(19) United States
(12) Patent Application Publication
(10) Pub. No.: US 2017/0338518 A1
(43) Pub. Date: Nov. 23, 2017

(54) CELL AND METHOD FOR FORMING THE SAME

(71) Applicant: Contemporary Amperex Technology Co., Limited, Ningde (CN)

(72) Inventors: Taosheng ZHU, Ningde (CN); Fenggang Zhao, Ningde (CN); Aiguo Zhang, Ningde (CN)

(73) Assignee: Contemporary Amperex Technology Co., Limited, Ningde (CN)

(21) Appl. No.: 15/221,369

(22) Filed: Jul. 27, 2016

(30) Foreign Application Priority Data
May 20, 2016 (CN) 201610339276.1

(51) Int. Cl. H01M 10/0587; H01M 10/04; H01M 10/0525

(52) U.S. Cl. CPC H01M 10/0587; H01M 10/0525; H01M 10/0431; H01M 2220/20; H01M 2220/10

(57) ABSTRACT

The present application relates to a cell and a method for forming the same. The cell is formed by alternative coiling of anode electrode piece, cathode electrode piece and insulation film, section of cell is of round angle square structure with four vertex angels being round angles. The forming method includes: a) placing cell to be pressed, so that cell is located among top plane, bottom plane and two lateral planes, side of the cell perpendicular to thickness direction contacts bottom plane, certain distance exists between each lateral plane and cell; b) thermo-compressing cell by adopting thermo-compressing manner, so that top plane, bottom plane and two lateral planes press cell together, until section having round angle square structure with four vertex angels being round angles is formed; c) shaping to form cell.

### TECHNICAL FIELD

The present application relates to the field of energy storage device production and, particularly, relates to a cell and a method for forming the cell.

### BACKGROUND

In recent years, problems such as environmental pollution and energy shortage are becoming more and more serious. Li-ion battery has already been widely used in the fields of communication and electron components, energy storage power station, new energy vehicle and so on due to its advantages such as environmental protection, high energy density, low self-discharging, long cycle life and so on, which plays a significant role in improving energy efficiency and protecting the environment.

The main structure of a Li-ion battery includes an anode electrode piece, a cathode electrode piece, an insulation film, electrolyte and an outer pack casing and so on. The anode, cathode electrode pieces and the insulation film are alternatively coiled together to form a cell, which is then outside packed and filled with liquid, then go through processes such as capacity formation, so as to form a complete Li-ion battery.

In order to increase the volume energy density of the Li-ion battery, generally, the prior art will shape the cell by thermo-compressing, to reduce the thickness of the cell. However, the cell will gradually protrude towards two sides thereof during the thickness compressing process, which causes that an R angle (referring to FIG. 1) with a radius almost equals to half of the thickness of the cell is presented at the side of the cell, under a certain thickness of the battery, the larger the R angle is, the larger the width of the cell is, the more the space is wasted, and the more the volume energy density is lost.

### SUMMARY

The present application provides a cell and a method for forming the cell, which can reduce the loss of the volume energy density.

In a first aspect, the present application provides a cell, formed by alternative coiling of an anode electrode piece, a cathode electrode piece and an insulation film, a section of the cell is of a round angle square structure with four vertex angels being round angles.

Preferably, the anode electrode piece, the cathode electrode piece and the insulation film are of a uniform thickness, respectively.

Preferably, a radius of the vertex angle is not smaller than a sum of single-layer thicknesses of the anode electrode piece, the cathode electrode piece and the insulation film, thickness of the cell is set as T, the radius of the vertex angle is smaller than T/2.

Preferably, value r of the four vertex angles of the cell is the same.

In a second aspect, the present application provides a method for forming the cell, including the following steps:

a) placing a cell to be pressed, so that the cell to be pressed is located among a top plane, a bottom plane and two lateral planes, a side of the cell to be pressed that is perpendicular to a thickness direction contacts the bottom plane, a certain distance exists between each lateral plane and the cell to be pressed;

b) thermo-compressing the cell to be pressed by adopting a thermo-compression manner, so that the top plane, the bottom plane and the two lateral planes press the cell to be pressed together, until a section having a round angle square structure with four vertex angels being round angles is formed;

c) shaping to form the cell.

Preferably, in step a), the bottom plane and the lateral planes at two sides together form a placing area, the cell to be pressed is disposed in the placing area formed by the bottom plane and the two lateral planes at two sides.

Preferably, in step a), distances between each of the two lateral planes and a center of the cell are the same.

Preferably, in step b), the lateral plane is fixed, the cell is pressed along the thickness direction, such that the thickness thereof is compressed, the two sides thereof protrude and contact the lateral planes and are pressed.

Preferably, in step b), the bottom plane and the lateral planes are fixed, the top plane moves downward and presses the cell to be pressed, after being pressed, the thickness of the cell to be pressed is compressed, the two sides thereof protrude and contact the lateral planes and are pressed.

Preferably, in step b), moving speed of thermo-compressing is 10˜2000 mm/min, temperature of thermo-compressing is 70˜90° C., pressure of thermo-compressing is 3˜5t, and time of thermo-compressing is 150s.

Preferably, the following step is also included before step a):

d) adjusting distance between the two lateral planes.

The technical solution provided by the present application can reach the following beneficial effects:

The forming method provided by the present application can form the cell having a section with a round angle square structure, so as to make use of the space at two sides of the cell more adequately, and improve the volume energy density of the Li-ion battery.

It should be understood that, the above general description and the following detailed description are just exemplary, which do not limit the present application.

### BRIEF DESCRIPTION OF DRAWINGS

FIG. 1 is a structural schematic diagram of a profile of a cell provided by the background of the present application.

FIG. 2 is a structural schematic diagram of a section of a cell provided by an embodiment of the present application.

FIG. 3 is a structural schematic diagram of a profile of a cell provided by an embodiment of the present application.

FIG. 4 is a schematic diagram of an integral structure of a cell thermo-compressing device provided by an embodiment of the present application.

FIG. 5 is a structural schematic diagram showing the cooperation of a bottom thermo-compressing block and a lateral thermo-compressing block provided by an embodiment of the present application.

### REFERENCE SIGNS

10—anode electrode piece;
12—cathode electrode piece;
14—insulation film;
20—power mechanism;
22—thermo-compressing mechanism;
220—top thermo-compressing block;
222—bottom thermo-compressing block;
222a—fixing hole;
224—lateral thermo-compressing block;
226—movable thermo-compressing block;
226a—bar-type hole;
24—fixing mechanism;
240—first fixing plate;
242—second fixing plate;
244—connecting column;
246—third fixing plate;
26—guiding mechanism;
260—guiding plate;
262—bearing.

The drawings are incorporated into the specification and constitute a part of the specification, which show embodiments of the present application, and are used to explain the principle of the present application together with the specification.

### DESCRIPTION OF EMBODIMENTS

The present application will be described in further detail through specific embodiments and accompany drawings. The “front”, “back”, “left”, “right”, “up”, “down” are referring to the placing state of the cell and the cell thermo-compressing device in the drawings.

As shown in FIG. 2, an embodiment of the present application provides a cell, which is formed by alternative coiling of an anode electrode piece 10, a cathode electrode piece 12 and an insulation film 14, distinguishing from the cell in the prior art, the section of the cell in the present embodiment is of a round angle square structure with all the four vertex angels being round angles.

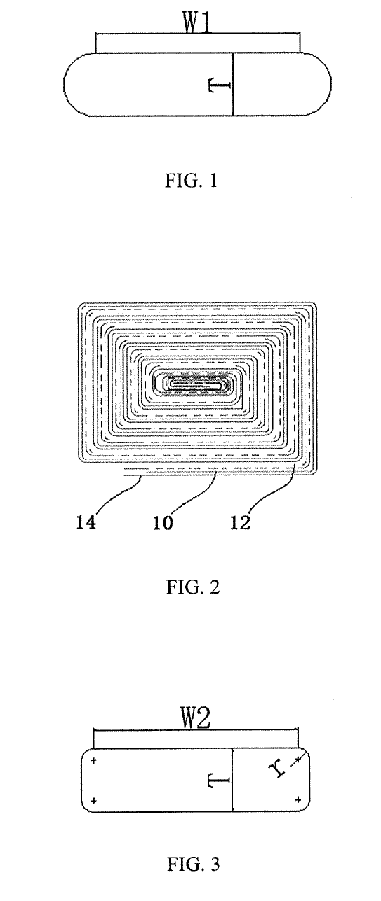

Referring to FIG. 1, the cell in the prior art will form a large R angle since the two sides of the cell are not limited during the forming process, which causes waste of the inner volume of the Li-ion battery, thereby reducing the volume energy density of the battery. Specifically, it is assumed that the width of the main body of the cell (the distance between the R angels at two sides) is W1, the thickness of the cell is T, the diameter of the R angle equals to the thickness T of the cell, then the total area occupied by the section of the cell M1=T(W1+T)=TW1+T².

However, the section of the cell in the present embodiment is of a round angle square structure, which will only have a small round angle r at four vertex angles, referring to FIG. 3, it is assumed that the width of the main body of the cell (the distance between the r angels at two sides) is W2, the thickness of the cell is still T, then the total area occupied by the section of the cell M2=T(W2+2r)=TW2+2rT.

In the present embodiment, since the width of the cell is limited during the thermo-compressing process, thus W2<W1, and at this time, since the round angle only exists at two ends of the side portions of the cell, the radius r of the round angle cannot reach T/2, thus 2r<T, therefore, M2<M1, which means in the situation that the thickness T of the cell and the actual sectional area are the same, the total area occupied by the section of the cell formed in the present embodiment is smaller than that of in the scheme of the prior art, therefore, the volume occupied is smaller, and the volume energy density is higher.

In the prior art, since there is no limitation at two sides of the cell, it is difficult to control the size of the R angle during thermo-compressing, the electrode piece may fracture. In order to prevent the electrode piece fracture, it is preferred that the anode electrode piece 10, the cathode electrode piece 12 and the insulation film 14 are of a uniform thickness, the partial thickness will not reduce even at the round angles, which can improve the intensity of the round angle, so as to prevent the electrode piece fracture. It is most preferred that the radius r of the four vertex angles is equal, so as to improve the regularity and the energy density of the cell. Furthermore, the present embodiment can also prevent the electrode piece fracture through adjusting the radius r of the vertex angle. In a general situation, the radius r of the vertex angle cannot be smaller than the sum of single-layer thickness of the anode electrode piece, the cathode electrode piece and the insulation film, and the radius r of the vertex angle is kept smaller than T/2.

In order to form the cell in the above embodiment, the present embodiment also provides a method for forming the cell, including the following steps:

a) Placing the cell to be pressed, so that the cell to be pressed is located among a top plane, a bottom plane and two lateral planes, a side of the cell to be pressed that is perpendicular to the thickness direction contacts the bottom plane, a certain distance exists between each lateral plane and the cell to be pressed.

The objective of this step is to dispose the cell to be thermo-compressed in a thermo-compressing space formed of the top plane, the bottom plane and the two lateral planes, and be prepared to be thermo-compressed. Considering the equilibrium of the pressing force received by the two sides of the cell during the thermo-compressing process, it is preferred that the distance between each of the two lateral planes and the center of the cell to be pressed is kept the same.

At this time, the bottom plane and the lateral planes at two sides can together form a placing area, the cell to be pressed is disposed in the placing area formed by the bottom plane and the two lateral planes at two sides. In the placing area, the distance between the two lateral planes can be fixed and non-adjustable, or can be adjustable. That is, before placing the cell to be pressed, firstly, execute step d) adjusting the distance between the two lateral planes, then execute step a).

After finishing step a), begin the next step:

b) thermo-compressing the cell to be pressed by adopting the thermo-compressing manner, so that the top plane, the bottom plane and the two lateral planes press the cell to be pressed at the same time, until a cell with a round angle square structure having the section with four vertex angels all being round angles is formed.

During the pressing process, the top plane and the bottom plane and the two lateral planes can move towards the center at the same time, so as to press the cell in all directions. However, this manner is considered to be poor in manipulation and coordination, thereby is not recommended. Generally, it is preferred to fix the lateral plane, and press the cell to be pressed along the thickness direction, such that the thickness thereof is compressed, the two sides thereof protrude and contact the lateral planes and then are pressed. It is only needed to manipulate the top plane or the bottom plane that can achieve pressing of the cell to be pressed in all directions, with better manipulation, meanwhile, since the two lateral planes are both fixed, thus, the application of force to the cell to be pressed is a passive force, which is easy to be controlled accurately. The best manner is to fix both the bottom plane and the lateral planes, and move the top plane downward to press the cell to be pressed. During the thermo-compressing process, since the cell is pressed from up, down, left and right, so the cell will fill the four corners, so as to improve the volume energy density while forming the round angles.

In this process, the load of the electrode piece can be adjusted through controlling various parameters of the thermo-compressing process, so as to control the quality of the cell. In the present embodiment, the moving speed of thermo-compressing can be kept in the range of 10˜2000 mm/min, the temperature of thermo-compressing is kept in 70˜90° C., the pressure of thermo-compressing is 3˜5t, and the time of thermo-compressing is around 150s. Generally, the slower the speed is, the better the excellent rate and the consistency of the cell pressed are, but the productivity is lower; the faster the speed is, the higher the efficiency is, but the excellent rate of the pressed product is a little lower. Through adjusting the various parameters, requirement of the cell with different r values can be adapted. For example, when the cell T needed to be pressed is quite small (the cell is quite thin), a small r angle is needed, the temperature and the pressure of thermo-compressing can also be relatively small.

Afterwards, executing the last step:

c) Complete thermo-compressing, shaping the cell.

The cell can be taken out after being shaped, then starts a new circulation.

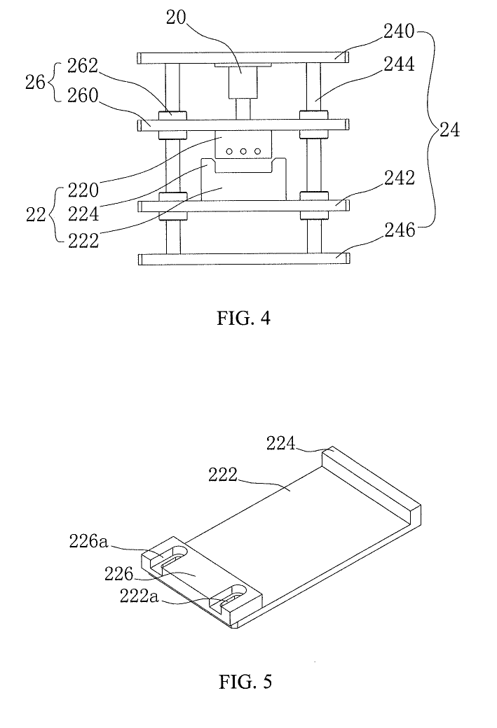

In order to realize the above forming manner, the present embodiment also provides a cell thermo-compressing device, as shown in FIG. 4, the main components thereof include a power mechanism 20 and a thermo-compressing mechanism 22, besides, may also include a fixing mechanism 24 and a guiding mechanism 26.

The thermo-compressing mechanism 22 includes a top plane, a bottom plane and two lateral planes, the top plane, the bottom plane and the two lateral planes together form a thermo-compressing space used for thermo-compressing the cell, these planes can be arranged on several mutually independent components, for example, in the present embodiment, the thermo-compressing mechanism 22 includes a top thermo-compressing block 220, a bottom thermo-compressing block 222 and two lateral thermo-compressing blocks 224, the top plane is located on the top thermo-compressing block 220, the bottom plane is located on the bottom thermo-compressing block 222, and the two lateral planes are respectively located on the two lateral thermo-compressing blocks 224. The power mechanism 20 is connected with the thermo-compressing mechanism 22, and drives the thermo-compressing mechanism 22 to move, reduces the thermo-compressing space, so as to press the cell to be pressed in all directions, and increase the volume energy density of the cell.

During the thermo-compressing process, it is preferred to drive the top thermo-compressing block 220 through the power mechanism 20, keep the bottom thermo-compressing block 222 and the two lateral thermo-compressing blocks 224 being relatively fixed.

Since different types of the cells are corresponding to different thicknesses and widths, in order to adapt the cell thermo-compressing device to more types of cell thermo-compressing processes, one or both of the two lateral thermo-compressing blocks 224 can be designed as a movable moving thermo-compressing block 226. Considering simplifying the structure and operation, only one of which can be a moving thermo-compressing block 226, the other one is fixedly connected with the bottom thermo-compressing block 222. The moving thermo-compressing block 226 is movably connected with the bottom thermo-compressing block 222, and can change the distance between the two lateral thermo-compressing blocks, so as to adapt cells with different widths.

As shown in FIG. 5, a bar-type hole 226a can be provided on the moving thermo-compressing block 226, the extending direction of the bar-type hole 226a is the same as the distance direction between the two lateral thermo-compressing blocks 224, a fixing hole 222a is provided on the bottom thermo-compressing block 222, a bolt (not shown in figures) passes through the bar-type hole 226a and is engaged and connected with the fixing hole 222a, so that the moving thermo-compressing block 226 is connected with the bottom thermo-compressing block 222.

The fixing mechanism 24 is used to fix the power mechanism 20 and the thermo-compressing mechanism 22. When adopting the thermo-compressing manner of downward pressing of the top thermo-compressing block 220, the power mechanism 20, such as an air cylinder, is fixed with the fixing mechanism 24, the bottom thermo-compressing block 222 is fixed on the fixing mechanism 24, the rest two lateral thermo-compressing blocks 224 are fixed through the bottom thermo-compressing block 222. Of course, the two lateral thermo-compressing blocks 224 can be directly fixed on the fixing mechanism 24.

As shown in FIG. 4, the fixing mechanism 24 of the present embodiment includes a first fixing plate 240, a second fixing plate 242 and a connecting column 244, besides, can also include a third fixing plate 246. The first fixing plate 240 and the second fixing plate 242 are arranged in parallel to each other, and the third fixing plate 246 is provided at a side of the second fixing plate 242 opposite to the first fixing plate 240, and is arranged in parallel to the second fixing plate, all the three plates are fixedly connected through the connecting column 244. The first fixing plate 240 and the second fixing plate 242 are mainly used to fix the power mechanism 20 and the thermo-compressing mechanism 22, and the third fixing plate can improve the stability of the fixing mechanism 24 itself, a plurality of connecting columns 244 can be arranged at the same time, so as to be fixedly connected in multiple directions. The power mechanism 20 and the thermo-compressing mechanism 22 are both located between the first fixing plate 240 and the second fixing plate 242, the power mechanism 20 is fixed at the lower surface of the first fixing plate 240, and the bottom thermo-compressing block 222 is arranged on the second fixing plate 242.

In order to make the moving process of the top thermo-compressing block 220 more stable, and prevent radial offset caused by other acting forces, the present embodiment also provides a guiding mechanism 26. The guiding mechanism 26 includes a guiding plate 260, and can also include a bearing 262. The guiding plate 260 is arranged in parallel to the first fixing plate 240 and the second fixing plate 242, a guiding hole 260a is provided on the guiding plate 260, the connecting column 244 passes through a guiding hole (not shown in figures), the power mechanism 20 is connected with the upper surface of the guiding plate 260, and the top thermo-compressing block 220 is fixed at the lower surface of the guiding plate 260. Firstly, the power mechanism 20 drives the guiding plate 260 to move, and the guiding plate 260 will drive the top thermo-compressing block 220 to move during moving. Meanwhile, since the connecting column 244 passes through the guiding hole on the guiding plate 260, so that the guiding plate 260 only moves alone the axial direction of the connecting column 244, so as to achieve guiding effect. The bearing 262 is fixed in the guiding hole, and is sleeved at the periphery of the connecting column 244, which achieves the effect of reducing the friction.

The cell thermo-compressing device provided by the embodiments of the present application can form the cell having the section with a round angle square structure through thermo-compressing, so as to make use of the space on two sides of the cell more adequately, and improve the volume energy density of the Li-ion battery. Besides, the cell thermo-compressing device also possesses characteristics of convenient operation, wide application and so on.

The above are just the preferred embodiments of the present application, and will not limit the present application, for those skilled in the art, the present application can have various modifications and variations. Any modifications, equivalent replacements and improvements made within the spirit and principle of the present application shall all fall in the protection scope of the present application

1. A cell, formed by alternative coiling of an anode electrode piece, a cathode electrode piece and an insulation film, wherein, a section of the cell is of a round angle square structure with four vertex angels being round angles.

2. The cell according to claim 1, wherein, the anode electrode piece, the cathode electrode piece and the insulation film are of a uniform thickness, respectively.

3. The cell according to claim 1, wherein, a radius of the vertex angle is not smaller than a sum of single-layer thicknesses of the anode electrode piece, the cathode electrode piece and the insulation film, the radius of the vertex angle is smaller than half of thickness of the cell.

4. The cell according to claim 3, wherein, value of the four vertex angles of the cell is the same.

5. A method for forming the cell according to claim 1, comprising the following steps:
a) placing a cell to be pressed, so that the cell to be pressed is located among a top plane, a bottom plane and two lateral planes, wherein, a side of the cell to be pressed that is perpendicular to a thickness direction contacts the bottom plane, a certain distance exists between each lateral plane and the cell to be pressed;
b) thermo-compressing the cell to be pressed by adopting a thermo-compressing manner, so that the top plane, the bottom plane and the two lateral planes press the cell to be pressed together, until a section having a round angle square structure with four vertex angels being round angles is formed;
c) shaping to form the cell.

6. The method for forming the cell according to claim 5, wherein, in step a), the bottom plane and the lateral planes at two sides together form a placing area, the cell to be pressed is disposed in the placing area formed by the bottom plane and the two lateral planes at two sides.

7. The method for forming the cell according to claim 6, wherein, in step a), distances between each of the two lateral planes and a center of the cell to be pressed are the same.

8. The method for forming the cell according to claim 6, wherein, in step b), the lateral plane is fixed, the cell to be pressed is pressed along the thickness direction, such that the thickness thereof is compressed, and the two sides thereof protrude and contact the lateral planes and are pressed.

9. The method for forming the cell according to claim 8, wherein, in step b), the bottom plane and the lateral planes are fixed, the top plane moves downward and presses the cell to be pressed, after being pressed, the thickness of the cell to be pressed is compressed, the two sides thereof protrude and contact the lateral planes and are pressed.

10. The method for forming the cell according to claim 5, wherein, in step b), moving speed of thermo-compressing is 10˜2000 mm/min, temperature of thermo-compressing is 70˜90° C., pressure of thermo-compressing is 3˜5t, and time of thermo-compressing is 150s.

11. The method for forming the cell according to claim 5, wherein, before step a), further comprising the following step:
d) adjusting distance between the two lateral planes.
